(19) United States
(12) Patent Application Publication
(10) Pub. No.: US 2010/0302708 A1
(43) Pub. Date: Dec. 2, 2010

(54) BIPOLAR SUPERCAPACITORS AND METHODS FOR MAKING SAME

(75) Inventors: Lih-Ren Shiue, Hsinchu (TW); Masami Goto, Tokyo (JP)

Correspondence Address: The Law Office of Michael E. Kondoudis, 888 16th Street, NW, Suite 800, Washington, DC, 20006, US

(73) Assignee: LINXROSS, INC., Tokyo (JP)

(21) Appl. No.: 12/595,521

(22) PCT Filed: Apr. 14, 2008
(86) PCT No.: PCT/JP2008/057641

§ 371 Date: Aug. 12, 2010

(30) Foreign Application Priority Data
Apr. 12, 2007 (JP) 2007-127371

(51) Int. Cl. H01G 9/016; H01G 9/06

(52) U.S. Cl. 361/502

(57) ABSTRACT

The present invention relates to a bipolar element for energy storage, which facilitates the manufacturing thereof with high working voltage. The bipolar element for energy storage includes two end electrodes with a dedicated means for connecting to a potential source; at least one intervening electrode disposed between the said end electrodes wherein the said intervening electrode has no connection to a potential source; and a separator disposed after each electrode for concentrically winding the said electrodes and separators into a jelly roll; or a separator disposed between every two electrode for stacking the said electrode and separator into a prismatic form; an organic electrolyte solution is added to the said separators for storing energy with a potential applied to the said end electrodes by the said power supply, wherein the bipolar element is partially sealed. The said assemblies of making high voltage supercapacitors in single units or modules can facilitate the usage of the devices as power managers in high power applications for automobiles, power tools, machineries and automatic system.

### TECHNICAL FIELD

This invention relates to the assembly of supercapacitor elements by using bipolar electrodes. More specifically, the invention relates to the methodologies for increasing the working voltage of a single unit of supercapacitor via intra-element series connection, as well as for increasing the working voltages and capacitances of supercapacitor modules via intra-housing series, parallel, and combination of the two connections.

### BACKGROUND ART

In the use of portable energy provided by batteries and fuel cells in particular, the delivery of peak powers is detrimental to both of the use-time and the lifetime of the devices. While a great amount of resources has been spent on improving the power output capability, or power density, of the two devices, their energy contents are inevitably compromised. Batteries and fuel cells are inherently inferior in the power density as the electric energies they discharge are converted from chemical reactions. Every kind of battery or fuel cell depends on a specific chemical reaction within the device's housing for delivering various electric powers. All chemical-reaction rates are governed by activation energy, phase change and composition restructure making the energy conversion sluggish. In comparison, supercapacitor utilizes surface adsorption of ions for storing electric energy at charging, and desorption of ions for delivering electric power at discharging. There is no energy conversion occurred in the discharging of supercapacitor, also the discharging is a rapid physical process leading to a high power density for the supercapacitor. Nevertheless, either water or an organic solvent is involved in the charging and discharging of batteries, fuel cells and supercapacitors, as the solvents are decomposed at low voltages, all of the foregoing energy devices are adversely characterized by low working voltages.

One common practice to attain high working voltages for batteries, fuel cells and supercapacitors is to connect the individual devices in series. In the serial pack, each device is separately pre-encapsulated into an independent unit. For protecting each member device from being overcharged when the pack is fully charged, a designated electronic circuit is installed for each device. The protection circuit is costly, and the serial pack with the inclusion of the circuits is bulky. A better solution to create a high working-voltage is to prepare batteries, fuel cells and supercapacitors using a bipolar design. The bipolar design is a stack of electrodes wherein only the end electrodes are connected to a power supply, whereas all of the intervening electrodes are charged positively on one side and negatively on the other face without a connection to the power supply. The intervening electrode have two different polarities on two faces, thus, they are called bipolar electrodes. The bipolar electrodes are commonly used in fuel cells since each cell can only generate a working voltage of 0.7 V. The bipolar electrodes are also utilized in batteries as seen in U.S. Pat. Nos. 3,954,502; 4,070,528; 4,211,833; 5,219,673; 5,582,937; 5,729,891; 5,955,215 and 6,656,639. In addition to the increase of working voltage, specific power is also increased from using bipolar electrode as disclosed in U.S. Pat. Nos. '502 and '833. Through the use of bipolar electrodes, a single unit of battery can have a high working-voltage. However, in all of the cited US patents, the batteries are consisted of either vertical or horizontal stacking of bipolar electrodes. There is no battery made by winding bipolar electrode with two end electrodes into single cylindrical rolls. Nevertheless, the cylindrical batteries, such as, alkaline battery, nickel metal hydride and lithium ion, dominate the consumer electronic markets.

A fabrication of cylindrical bipolar supercapacitors has been disclosed in U.S. Pat. Nos. 6,510,043 and 6,579,327. In the fabrication, a bipolar electrode is wound concentrically with two end electrodes into a jelly roll, which is turned into a single supercapacitor capable of operating at twice voltages of its counterpart without the bipolar electrode. As the number of bipolar electrode is increased by one, the cell number is also increased by one resulting in the increase of working voltage by one unit. For supercapacitors using an organic electrolyte, the working voltage will be boosted by 2.3 to 2.5 V on adding one bipolar electrode to the element assembly of capacitor. Another fabrication of supercapacitor with high working-voltage is the stacking of plural bipolar electrodes as disclosed in U.S. Pat. Nos. 6,174,337; 6,187,061 and 6,576,365. All five patents, U.S. Pat. Nos. '043, '327, '337, '061 and '365, can be classified as a cell assembly via “intra-element series connection” since two end electrodes and all polar electrodes are integrated into a single capacitor element. In the same token, the bipolar batteries of U.S. Pat. Nos. '502 to '639 cited in the last paragraph belong to an “intra-element series connection” as well. The foregoing bipolar batteries and bipolar supercapacitors share the complicate and hard processes on sealing the edges of all cells within the elements to prevent the communication of electrolyte among the cells. The difficulties in the fabrication steps lead to a unprofitable mass production, specifically, when the number of bipolar-electrode is more than two in the winding process ('043 and '327), and more than ten in the stacking operation ('337, '061 and '365) of cell assembly.

Actually, the complicate edge-sealing procedures are unnecessary for making the bipolar energy-storage devices or electrochemical cells. For example, the bipolar electrodes can be in the form of 0.5-1 mm diameter balls in the electrochemical cell disclosed in U.S. Pat. No. 6,306,270. There is no edge sealing for the ball-type bipolar electrodes of U.S. Pat. No. '270, and the bipolar electrodes act as they are in series connection. Furthermore, as taught in U.S. Pat. No. 7,145,763, single cylindrical supercapacitors with high working-voltages can be prepared by coating activated carbon in predetermined intervals on two separate aluminum foils that are isolated by two separators soaked with an organic electrolyte. Each pair of oppositely facing surfaces of carbon layers constitutes a cell and a number of facing surfaces, or cells, can be deployed in one capacitor element that is formed by concentric winding of two carbon-coated aluminum foils accompanied with two separators. As seen in FIG. 8 of U.S. Pat. No. '763, with two end electrodes connected to a power supply, all of the intervening cells are charged without a connection to the power supply. Moreover, instead of two polarities developed on two sides of one electrode, the two polarities appear on the same side of an electrode. Many cells within the element share a same separator without edge sealing, the electrolyte can travel from one cell to the adjacent cells. Nonetheless, the supercapacitors as prepared in '763 are reported to have rated working-voltages of 6 V or higher. The coating of carbon with 20 mm interruption as proposed in '763 is not a viable way of mass production, besides, the highest realizable working-voltage of the supercapacitor is limited by the leakage current, which is proportional to the number of cells contained in one element.

From the perspective of fabrication of the integrated high-voltage supercapacitors, multiple elements can be also assembled in serial connection within a single housing. The foregoing assembly of the capacitor elements can be described as intra-housing series connection as revealed in U.S. Pat. Nos. 6,762,926 and 6,909,595. Both patents are also impeded by the edge sealing on scaling up the working voltages. In U.S. Pat. No. '926, supercapacitor modules with high working-voltages are made by placing one element in each of the compartments of a single housing so that electrolyte is confined within every compartment. All of the elements are then serially connected to generate the desired working-voltages, which is the product of number of elements in series multiplied by the unitary voltage per element. Obviously, the compartment number of the module housing is the major factor to determine the highest attainable working-voltage for the supercapacitor modules. On the other hand, a sheath in the shape of shrink hose or heat shrinkable tube is used for sealing the edges of every element serially connected in a single housing in U.S. Pat. No. '595. Once again, the edge sealing presents problems of cost and throughput to the production of supercapacitors equipped with very high working-voltages. Therefore, there is a need of methods for preparing the supercapacitor devices or modules in compact sizes with tailor made working-voltages at low cost and high throughput.

### DISCLOSURE OF THE INVENTION

### Technical Problem

The present invention is to solve the problems possessed by the prior art as mentioned above.

### Technical Solution

(1) A first aspect of the present invention is to provide a bipolar element for energy storage comprising:

two end electrodes with a dedicated means for connecting to a potential source;

at least one intervening electrode disposed between the said end electrodes wherein the said intervening electrode has no connection to a potential source; and

a separator disposed after each electrode for concentrically winding the said electrodes and separators into a jelly roll; or

a separator disposed between every two electrode for stacking the said electrode and separator into a prismatic form;

wherein the bipolar element is partially sealed.

The following are preferred embodiment of the first aspect of the invention.

i) The said jelly roll is sealed on the end that has no connecting means to a potential source.
ii) The said jelly roll is sealed through dip coating, spin coating or injection molding.
iii) The said jelly roll is sealed by an adhesive selected from a group of materials including epoxy, rubber, silicone, and urethane.
iv) The prismatic element is sealed on three edges that have no connecting means to a potential source.
v) The said prismatic element is sealed through dip coating, spin coating or injection molding.
iv) The said prismatic element is sealed by an adhesive selected from a group of materials including epoxy, rubber, silicone, and urethane.
vii) The said organic electrolyte solution contains a salt selected from tetraethyl ammonium tetrafluoroborate, tetramethyl ammonium tetrafluoroborate, or methyl triethyl ammonium tetrafluoroborate.
viii) The said organic electrolyte solution contains a solvent selected from acetonitrile, dimethyl carbonate, diethyl carbonate, ethylene carbonate, methyl ethyl carbonate, methyl propyl carbonate, propylene carbonate, γ-butyrolactone, combination of two, or combination of three of the above.

A second aspect of the present invention is to provide a bipolar supercapacitor for energy storage comprising:

at least one bipolar element; set forth in the first aspect of the present invention;

at least one element;

at least two dedicated means for each said element for electric connection;

at least one metal foil or wire for connecting the said elements;

a housing for containing the said elements; and

a top cap for forming hermetical seal with the said housing.

The following are preferred embodiments of the second aspect of the present invention.

i) The said elements are connected via series connection, parallel connection, or combination of the two.
ii) The said housing and cap are selected from a group of materials containing aluminum, stainless steel, polyethylene, and polypropylene.
iii) The said elements can store an amount of energy capable of working at 2.3 V and above.
iv) The said elements can store an amount of electric charge of 1 F and above.

The above “at least one element” in the second aspect of the present invention may be the bipolar element set forth in the first aspect of the present invention or a different one therefrom.

### ADVANTAGEOUS EFFECTS

The present invention offers a number of methods for fabricating high voltage supercapacitor devices or modules through intra-element or intra-housing series connections of bipolar electrodes or bipolar elements. In the intra-element assembly, a plural number of electrodes are either wound concentrically into a cylindrical element, or stacked lengthily into a rectangle element. Only the two end electrodes of the tied elements are connected to a power supply to receive charges for becoming monopolar electrodes, whereas the intervening electrodes are charged to positive polarity on one side and negative on the other, thus, they are bipolar electrodes connected in series without a connection to the power supply. Collectively, the two monopolar electrodes and the series of bipolar electrodes form the high voltage supercapacitor in single devices. Furthermore, by disposing a plural number of bipolar elements in a single housing for the intra-housing series connection, a supercapacitor module with high working-voltage in compact size is created. For making a supercapacitor module with high voltage, as well as high capacitance, a plural number of the bipolar elements in the desired voltage are connected in parallel within the single housing. Note that an organic electrolyte solution is added to the said separators for storing energy with a potential applied to the said end electrodes by the said power supply.

During the preparation of the bipolar elements by winding or stacking, the edges of the member electrodes in the element are open without sealing. The bipolar electrodes serve as the connectors for connecting the cells in series within the elements. Because the two end electrodes will face each other in the winding process, two solutions are proposed to solve the voltage mismatch between the cell formed by the end electrodes and the cells formed by the bipolar electrodes. One approach is to isolate the cells of the monopolar electrodes by leaving the facing sides of the two end electrodes no capability of charge-storage. The element is virtually composed of the end electrodes and bipolar electrodes disposed between them. Another approach is to place an equal number of bipolar electrodes after each monopolar electrode for concentric winding into a jelly roll. As a result, there are two symmetrical bipolar sub-elements, wherein each sub-element is a series connection of multiple electrodes including two end electrodes and bipolar electrodes there between, connected in parallel within the element.

In spite of the configuration of bipolar elements, only the edges of the completed elements are sealed with an adhesive as the finale of element-assembly. This seal is different from the edge sealing of each of the individual electrodes at the fabrications of bipolar elements. Edge sealing of an element is much more cost and labor effective than that of a single electrode. In sealing the edges of supercapacitor elements, there is always one edge unsealed, which is the edge with electrical leads protruding out of the elements. The unsealed edge is reserved for adding an electrolyte to the elements to complete the fabrication of supercapacitor devices or modules. Moreover, the open edge serves as a vent for releasing gases that may be produced during the high rates discharging of supercapacitors.

### BRIEF DESCRIPTION OF DRAWINGS

The present invention is best understood by reference to the embodiments described in the subsequent section accompanied with the following drawings.

FIG. 1 is a schematic diagram of a conventional supercapacitor made by concentric winding.

FIG. 2A is a symbolic diagram of two end electrodes and one bipolar electrode with separators before winding process.

FIG. 2B is a symbolic diagram of two end electrodes and one bipolar electrode with separators after concentric winding process, wherein the end electrodes face each other.

FIG. 3A is a symbolic diagram of two end electrodes and two bipolar electrode with separators before winding process. Each end electrode is followed by a bipolar electrode.

FIG. 3B is a symbolic diagram of two end electrodes and two bipolar electrodes with separators after concentric winding, wherein two sub-elements are connected in parallel on using the same end electrodes.

FIG. 4A is a schematic diagram of a stack of 7 rectangle electrodes including two end electrodes with tabs for electrical connection and 5 bipolar electrodes.

FIG. 4B is a schematic diagram of a stack of 7 separators to be inserted into the electrode stack of FIG. 4A by disposing one separator after one electrode.

FIG. 4C is a schematic diagram of a stack of 7 electrodes with 7 separators in a housing.

FIG. 4D is a schematic diagram of 3 stacks of bipolar elements connected in parallel within a single housing.

FIG. 5 shows the comparisons of cyclic voltammograms (CVs) between a bipolar supercapacitor and two serially connected regular supercapacitors, as well as the initial CV scan and the 2000^{th} CV scan of the bipolar supercapacitor.

FIG. 6 is a discharge curve of a 60 V×0.2 F supercapcitor discharging at 0.5 A rate.

### BEST MODE FOR CARRYING OUT THE INVENTION

### Definition of Terminologies

In order to clearly understand the present invention, several key terminologies are defined as follows:
Cell—A cell is formed by a pair of positive and negative electrodes, wherein the two electrodes have to face each other to make the cell effective.
Element—An element can be constituted by one cell or multiple cells, that is, two electrodes or multiple electrodes can make an element. Two of the electrodes should provide a means for the element to receive or to deliver electric power.
Monopolar—The sole polarity carried by an electrode which is same as the pole of a power source, either positive or negative, connected by the electrode.
Bipolar—Two different polarities reside on two sides, or the same side, of an electrode. The polarities are induced by an electric field and a fluid conductor.
Intra-element Series Connection—A plural number of electrodes are connected in series within an element.
Intra-housing Series/Parallel Connection—A plural number of elements are connected in series, or in parallel, within a single housing that can provide a hermetical encapsulation to all elements therein.

The preferred embodiments of the bipolar supercapacitors of the present invention are presented as follows.

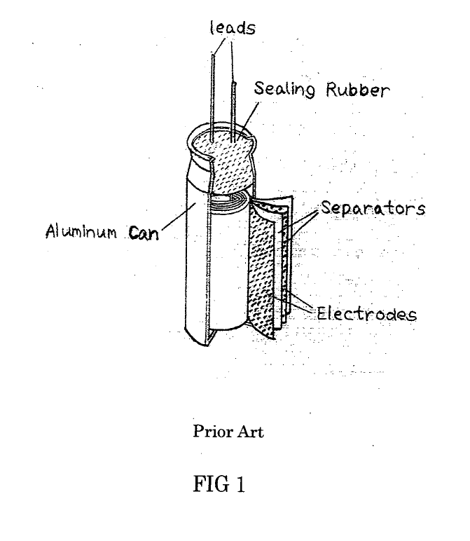

FIG. 1 shows a prior art of a cylindrical supercapacitor made by winding two sheets of electrode and two sheets of separator concentrically into a round element. As shown in FIG. 1, the element is disposed in an aluminum can with two leads that are bound to the electrodes with extension protruding out of the can through a rubber sealing cap for connecting to a power supply for receiving charge, or connecting to a load for delivering electric powers. By tradition, the leads are provided in different length giving the longer lead as the positive pole and the shorter one as the negative pole. Actually, the two electrodes are made of the same materials, such as, activated carbon coated on aluminum foil, they are identical allowing interchangeable use of the electrodes as positive or negative pole. Neither electrode has a permanently fixed polarity. Though supercapacitor may belong to an electrochemical device, the electric energy stored in the capacitor does not come from an electrochemical reaction, rather, the energy is a product of surface adsorption of ions by the charged electrodes. The ions are supplied by an electrolyte contained in the separators, which also prevent the electrodes from electric short.

In order to produce a high working-voltage for the supercapacitor, an organic electrolyte is often used. For example, tetraethyl ammonium tetrafluoroborate [(C₂H₅)₄NBF₄] as electrolyte that provides (C₂H₅)₄N⁺ and BF₄⁻, in propylene carbonate (PC) or 1,2-propanediol cyclic carbonate (C₄H₆O₃) as solvent can impart a working voltage of 2.5±0.2 V to the supercapacitors employing the electrolyte solution. Other candidates for the electrolyte include tetramethyl ammonium tetrafluoroborate, and methyl triethyl ammonium tetrafluoroborate. The alternative solvents may include acetonitrile, dimethyl carbonate, diethyl carbonate, ethylene carbonate, methyl ethyl carbonate, methyl propyl carbonate, γ-butyrolactone and the combination of two or three aforementioned solvents. All organic electrolyte solutions can grant the high working voltage to the supercapacitors. Nevertheless, if an aqueous solution is used as the electrolyte for supercapacitor, the working voltage will be as low as 0.8-1.0 V. The nominal energy content (E) of the supercapacitors is proportional to the square of rated working-voltage as shown in the following equation:

E=½ CV²

wherein C is the capacitance of the capacitor. As indicated by the above equation, it is more advantageous to increase V than C for enhancing the energy that can be stored in the supercapacitor. Moreover, many of the present electronic products require a minimum voltage of 3.3 V to drive the devices, it needs at least two units of the 2.5 V supercapacitor connected in series for the operations.

Thus, high working voltage is beneficial to supercapacitors in many power applications. It is an incessant endeavor to develop new electrolytes, which is the key to the working voltage of capacitor, for increasing the unitary voltage of supercapacitors. Nevertheless, the new chemistry innovations are often some expensive chemicals that have no commercial merit to the supercapacitors. In addition to the series connection of plural number of individual units into bulky packs, high energy supercapacitors in compact sizes with the desired working voltages can be economically and facilely fabricated through several unique cell assemblies. One method is the use of bipolar cell arrangement as described in the US patents cited in the paragraph of “Background of the Invention” and Annu. Rep. Prog. Chem., Sec. C, 1999, 95, pp 163-197.

In the multi-electrode bipolar elements, whether they are in round or square configuration, only the two very end electrodes are connected to a power supply or to a load, whereas the intervening electrodes have no connection to the power supply. Each of the middle electrodes can receive electric charges through the electric field built by the potential applied to the end electrodes and the conducting electrolyte that contacts the electrodes. Actually, in addition to energy storage, the bipolar electrodes also serve as the electric connectors to integrate all cells into a compact element with high working-voltage, which is described as “intra-element series connection”. Comparing to the conventional series connection of individual units of supercapacitor, the intra-element series connection can produce single supercapacitor units with high working-voltage in small volume and low material consumption. Most importantly, the intra-element series connection can be an economical way of mass production of high voltage supercapacitors.

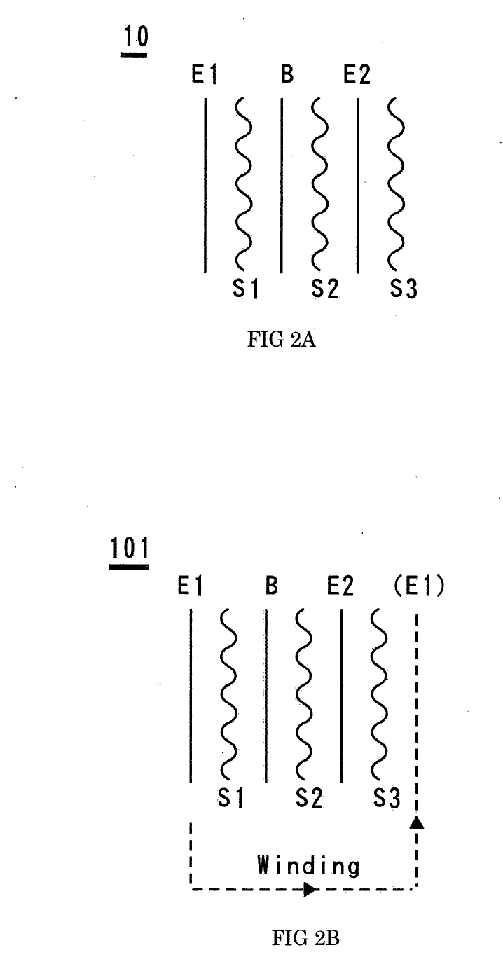

FIG. 2 shows the first preferred embodiment of a cell assembly using 3 electrodes to fabricate high-voltage supercapacitors. In FIG. 2A, the two end electrodes, E1 and E2, interposed by a bipolar electrode B, concurrently, with a separator, S, placed after each electrode, are deployed in sequence before concentric winding. All 3 electrodes, E1, E2 and B, are prepared identically, for example, activated carbon powder coated on aluminum foil. The 3 separators, S1 to S3, are porous polypropylene sheets used to protect the three electrodes from electric shorts and to contain an electrolyte solution. In the presence of electrolyte and a DC potential applied to the end electrodes, the end electrodes will be charged to the same polarity as the poles of the potential source that the end electrodes are connected. Assuming E1 is positive and E2 negative, then one side of B that faces E1 will carry negative polarity, whereas the E2-facing side of B will be positive.

Without a physical connection to the power supply, the different polarities arisen on the two sides of B are induced by the electric field built between E1 and E2 in conjunction with the conductivity of electrolyte. Since a cell is formed by a pair of positive and negative electrodes, the configuration of FIG. 2A is two cells, that is, E1/B and B/E2, connected in series, thus, the resulted voltage will be twice of that of E1/E2 alone. If cell E1/E2 has a working voltage of 2.5 V, then, the working voltage of the combinatory cells E1/B/E2 will be 5.0 V. As the six sheets including 3 electrodes and 3 separators are wound concentrically, the end electrodes, E1 and E2, will be opposite to each other as shown in FIG. 2B. By examining FIG. 2B carefully, it can be seen that two cells, E1/B/E2 and E1/E2, are connected in parallel by sharing the same pair of end electrodes, E1 and E2. Connecting a 5.0 V cell with a 2.5 V cell in parallel into a single device, the device can only be charged and utilized at 2.5V, otherwise, the lower voltage cell will be ruined at 5.0 V. One solution to make E1/E2 compatible with E1/B/E2 for working at 5.0 V is to coat only one side of E1 and E2 with activated carbon leaving the other side of each electrode uncoated. Furthermore, the blank sides of E1 and E2, which will be facing each other after winding, are insulated nullifying the formation of E1/E2 (the insulated E1 and E2 are no longer electrodes). Thereupon, E1/B/E2 will act alone as a 5.0 V capacitor.

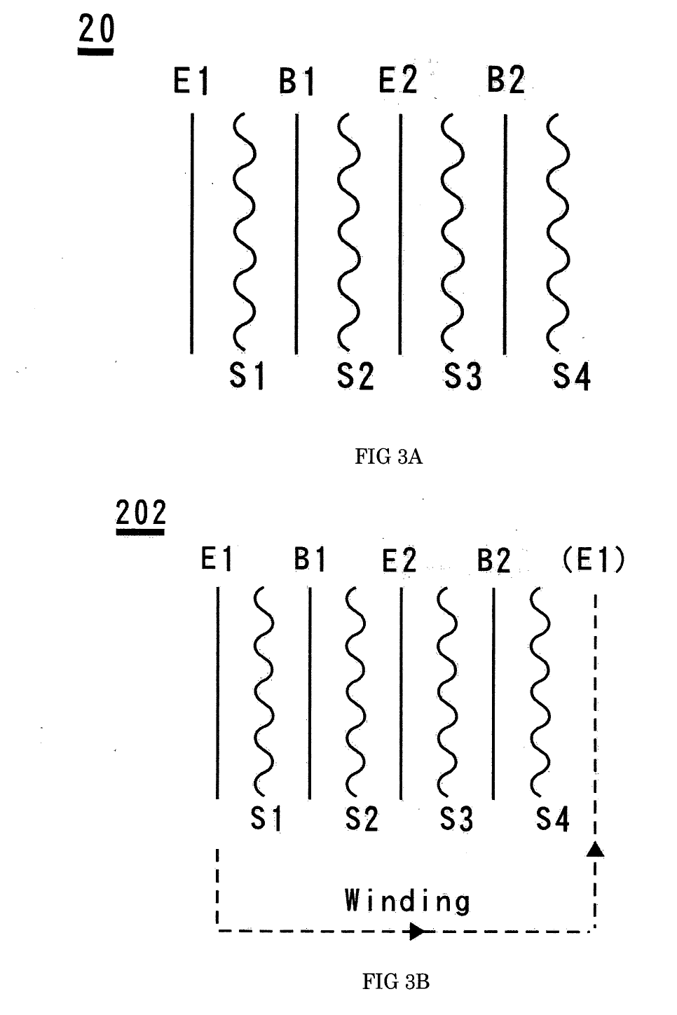

FIG. 3 presents another solution for solving the voltage imbalance of cells within the cylindrical bipolar supercapacitors. In the pre-winding configuration of FIG. 3A, the end electrode E1 and E2 are followed by bipolar electrodes B1 and B2, respectively. Each electrode is further affixed with a separator, S1 to S4. The eight sheets including four electrodes and four separators are wound concentrically leading to the contact of E1 and E2 as shown in FIG. 3B. In the foregoing assembly, there are two combinatory cells, E1/B1/E2 and E1/B2/E2, are connected in parallel by sharing the same pair of end electrodes. Each of the combinatory cells is a series connection of two cells via a bipolar electrode as the electric connector. In summary, there are four capacitor cells (by listing the positive electrode first, they are E1/B1, B1/E2, B2/E2 and E1/B2) in FIG. 3B, wherein the first two cells, E1/B1 and B1/E2, are connected in series, so are the other two cells, B2/E2 and E1/B2. Then, the two serially connected packs are hooked in parallel within the element. The foregoing element is consisted of cells in both series and parallel connections. As long as a winding machine can handle many rolls of electrode sheet and separator sheet simultaneously in the process of concentric winding, a number of bipolar electrodes can be included in the assembly of FIG. 2B or FIG. 3B. Using an aqueous electrolyte, every increment of bipolar electrode will boost the supercapacitors by 1.0 V, whereas an organic electrolyte will add at least 2.5±0.2 V to the supercapacitors on adding one bipolar electrode to the elements.

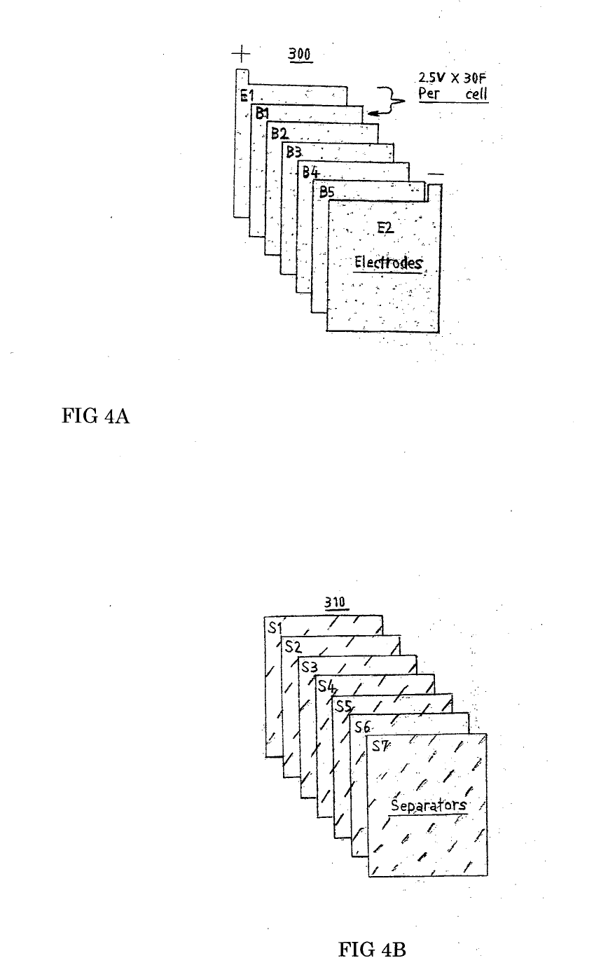

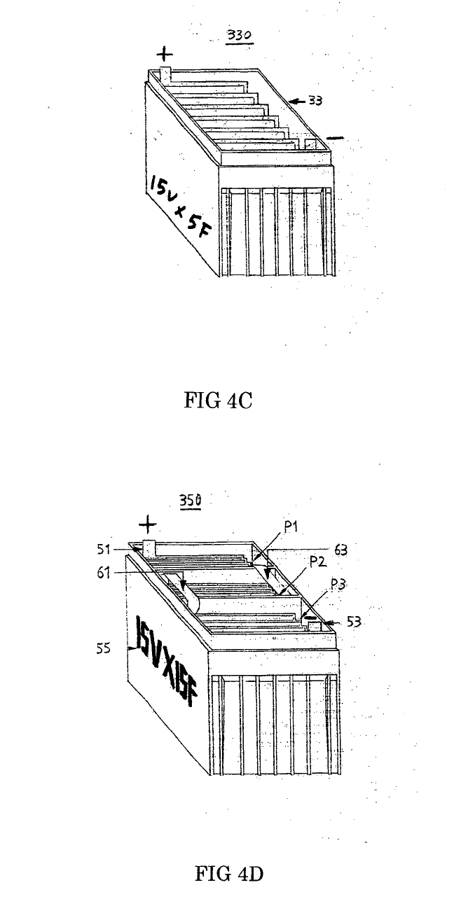

The fabrication of the elements of cylindrical supercapacitors solely depends on winding machine. Although more bipolar electrodes may generate higher working voltages for the supercapacitors, the construction of the winding machine may be difficult and expensive, and the operation of machine may become complicate. Hence, the number of bipolar electrode that may be included in the “intra-element series connection” of winding process is limited. In comparison, the “intra-element series connection” of stacking assembly into prismatic element is much easier on fabricating the capacitors with high working-voltages as seen in FIG. 4A to 4C. FIG. 4A shows a stacking assembly of seven supercapacitor electrodes, 300, including two end electrodes E1 and E2 with tabs for connecting to a power supply, as well as five bipolar ones, B1 to B5. Using an organic electrolyte and an electrode area of 20 cm², each cell in the stack 300 can yield a working voltage of 2.5 V and a capacitance of 30 F. After inserting the six pack of separators (S1 to S6) pack 310 of FIG. 4B sequentially into the electrode gaps of the pack 300 in the numerical order, that is, S1 goes to the first electrode gap, S2 to the second gap, and so on, then a prismatic element, 330, is built within the housing 33 as shown in FIG. 4C.

Since all six cells of the electrode assembly 300 are connected in series via the bipolar electrodes, so that the element will have an overall working-voltage of 15 V, sum of the six individual voltages, and the overall capacitance is the individual capacitance divided by the number of cells in series, or 5 F. When three of the 15 V×5 F elements, P1 to P3, are further connected in parallel, that is, all three positive electrode tabs are bound by the electric connector 61 and all negative electrode tabs by the connector 63, as depicted in FIG. 4D, a compact supercapacitor module 350 with a working voltage of 15 V and a capacitance of 15 F is constructed within the single housing 55. The housing and its cap can from a hermetical seal to isolate the elements within the casing from the environmental aggressors, such as, moisture and oxygen. Aluminum, stainless steel, polyethylene or polypropylene can be used as the material for the housing and cap. All three elements, P1 to P3, are contained in a single housing 55, they are assembled via the “intra-housing parallel connection”. Contrarily, if the same three elements, P1 to P3, are connected in series within the housing 55, then a supercapacitor with higher working voltage and lower capacitance, or 45 V×1.67 F, will be formed. The foregoing assembly of elements belongs to “intra-housing series connection”. By using the “intra-element” and “in-housing” series, parallel, or combined connections, supercapacitors in single devices or compact modules at desired voltages, capacitance and dimensions may be custom made.

Instead of sealing the perimeter of every individual electrode forming the bipolar elements in cylindrical or prismatic configuration, the elements after the assembly operations only requires partial sealing of the edges. In the case of cylindrical form as shown in FIG. 1, only the bottom of the roll is sealed with an adhesive, whereas the top side with two electric leads sticking out of the roll is left open for injecting the organic electrolyte into the element. The opening may also allow gas, which may be produced during the operation of supercapacitor, to escape from the element. Similarly, only three edges of the prismatic element as shown in FIG. 4C are sealed leaving the side with two electric tabs open for the injection of electrolyte or the ventilation of gas. Without all-around edge-seal of every electrode in the bipolar elements, electrolyte might migrate among the cells within the elements leading to inter-electrode shorting between the surfaces of the adjacent electrodes known as “treeing”. Electrode shorting may cause the failure of series connection, or disappearance of high working voltage. Nevertheless, even in a pool of electrolyte, electrochemical cells using the bipolar electrodes have attained high working voltages via the series connection of the intervening electrodes without edge sealing, for example, U.S. Pat. Nos. 6,307,270 and 3,954,502, which are incorporated in their entirety as references.

In the use of supercapacitors, it is the gas evolution, from the reactions between impurities and exposed metal substrate, which is detrimental to the reliability of the capacitor. Therefore, all materials including activated carbon, binder, and electrolyte used to fabricate the supercapacitors are strictly regulated, and the preparation of elements by either winding or stacking is conducted under the highest tension control of both the electrode and separator sheets. Essentially, the partial edge-sealing of the packed elements may prevent the exposed or uncoated metal of the substrate from reacting with impurity, such as, water that may be present. The edge-sealing of the present invention can be carried out by dip coating, spin coating or injection molding of epoxy, rubber, silicone or urethane on the edges to be sealed. Moreover, the partial sealing of the elements can greatly facilitate the mass production of the high working voltage supercapacitors.

Using the high-voltage elements as building blocks, various compact supercapacitor modules at advanced voltages, capacitances and energy contents may be conveniently produced via the “intra-housing series/parallel connection”. From cost perspective, since a single housing is shared by a plural number of elements, the “intra-housing connection” will consume less encapsulation materials than the conventional series connection of individually encapsulated units to form the supercapacitor packs of the same working voltages. Most importantly, the capacitor modules fabricated according to the “intra-housing series connection” of the invention will have a uniform voltage distribution among the member elements as the modules are fully charged to the rated voltages. The even distribution of voltages is due to a uniform temperature and vapor pressure environment is shared by all elements in the housing, as well as the close proximity of cells permitting short connectors for connecting the elements, which lead to low electric resistance. As a result, no protection circuit is required for each of the elements connected in series for the prevention of voltage imbalance from charging and discharging.

### Example 1

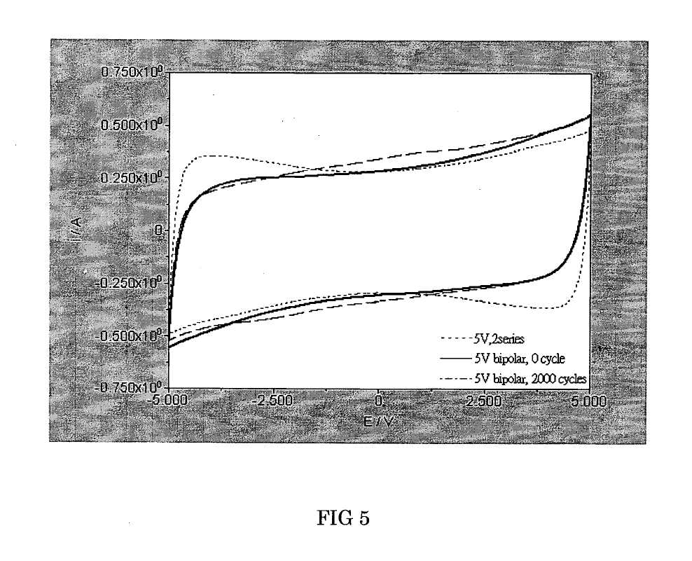

Two types of supercapacitors, regular (A) and bipolar (B), are prepared using the same substrate, activated carbon, organic electrolyte, but they are encapsulated in aluminum cans of different lengths, and A has two electrodes with both sides coated, whereas B contains two end electrodes with only one side coated and one bipolar electrode. Supercapacitors A and B are compared in Table 1 and FIG. 5.

TABLE 1
Comparison of Regular and Bipolar Supercapacitors

| Supercapacitors | A | B |
|---|---|---|
| Unitary Working-Voltage (V) | 2.5 | 5.0 |
| Unitary Capacitance (F) | 12 | 6 |
| Casing (diameter × length, | 18 Φ × 25 | 18 Φ × 36 |
| in mm) | | |
| Unitary Weight (g) | 8.0 | 13.4 |

As revealed by Table 1, it needs 2 units of supercapacitor A connected in series to achieve the same working voltage as supercapacitor B. Consequently, the two As will have at least 36 mm in diameter and 16 g in weight, which are apparently bulkier than supercapacitor B. Both of the serially connected supercapacitors and B are inspected and characterized by cyclic voltammetry (CV) test without using a reference electrode. As shown in FIG. 5, the CV is scanned at 50 mV/sec scan rate between the potential window of −5.0 V and 5.0 V, wherein the variations of current (i) are recorded with the continuous changes of voltage (E). At the first cycle of CV scan, the regular pack of supercapacitors shows faster switching of current as the scan is inverted at both ends of the voltage window than B indicating that the single bipolar supercapacitor has a higher ESR (equivalent series resistance) than that of the regular counterpart. Lower capacitance and higher ESR are usually seen for the bipolar supercapacitors than the regular supercapacitors connected in series for the same working-voltages, and this is due to that electrode area is significantly minimized and cells are in series connection within the elements of. bipolar supercapacitors. Nevertheless, the high working voltage and compact size presented by the bipolar supercapacitors are good merits to some applications, such as, computers and hand-held electronics, wherein capacitance and ESR are generally not emphasized. FIG. 5 also shows the virtual overlap of the 2000^{th} cyclic voltammogram of supercapacitor B with the profile of the first scan of B indicating that there is no decay of B at charging-discharging cycles. Henceforth, the “intra-element series connection” of the invention not only simplifies the fabrication process of bipolar supercapacitor, it also imparts sufficient reliability to the capacitor generated.

### Example 2

Similar to Example 1, five bipolar supercapacitors using 3 bipolar electrodes to have a working voltage of 10 V are prepared. The electric characters of the five 10-V supercapacitor devices containing 5-electrode within one element are measured and listed in Table 2.

TABLE 2
Electrical Specifications of 10-V Supercapacitors^{§}

| | Electrical Specifications | | |
|---|---|---|---|
| | Capacitance | ESR (mΩ) @ | IR Drop |
| # | (F)* | 1 KHz | (V)* |
| 1 | 1.56 | 189 | 0.31 |
| 2 | 1.55 | 186 | 0.31 |
| 3 | 1.59 | 195 | 0.44 |
| 4 | 1.56 | 193 | 0.43 |
| 5 | 1.58 | 192 | 0.38 |

^{§}in cylindrical form and dimension of 18 Φ × 36 mm.
*measured at 1 A discharge rate.

As seen in Table 2, the five cylindrical supercapacitors are fairly even in all three electrical properties. The IR, product of current (I) and resistance (R), drop is the loss of usable energy stored in a capacitor, which has internal resistance R, at the initiation of discharge at current I. The lower the IR drop the more the energy is available for work. There are 5 sheets of electrode wound concentrically with 5 sheets of separator in the bipolar supercapacitors of Table 2. Such winding machine with 10 rollers is not manufactured yet. Thus, the bipolar supercapacitors of Table 2 are hand made. Based on the outcomes of manual products, the machine should yield high consistency from the perspective of mass production.

### Example 3

Four rectangle supercapacitors are prepared using multiple thin electrode plates of 5 cm×10 cm dimension and the same number of separators in slightly larger size according to FIG. 4A to 4C. In addition to two end electrodes with tabs used in every element, the four electrode stacks are divided in two groups by giving 25 bipolar electrodes to the first group, and 26 bipolar electrodes for the second group. All four electrode stacks are sealed on three edges leaving the edge with tabs open, whereby an organic electrolyte is injected into the elements. Finally, the four elements are individually encapsulated in slim plastic housings to form capacitors with dimensions of 63 mm×130 mm×12 mm (thick). The physical properties of the four bipolar supercapacitors are measured in Table 3.

TABLE 3
Physical Properties of Four Rectangle Bipolar Supercapacitors

| | Measures | | | |
|---|---|---|---|---|
| Physical Properties | 1 | 2 | 3 | 4 |
| Number of Total Plates | 27 | | 28 | |
| Capacitance (F) | 0.29 | 0.26 | 0.27 | 0.25 |
| ESR (Ω) | 0.98 | 0.93 | 1.10 | 1.05 |
| Theoretical Working | 65.0 | | 67.5 | |
| Voltage (V) | | | | |
| Leakage Current @ | 32 | 31 | 28 | 26 |
| 30 V (mA) | | | | |
| Leakage Current @ | 122 | 128 | 90 | 92 |
| 60 V (mA) | | | | |
| Unitary Weight (g) | 100.8 | 101.0 | 102.1 | 102.3 |

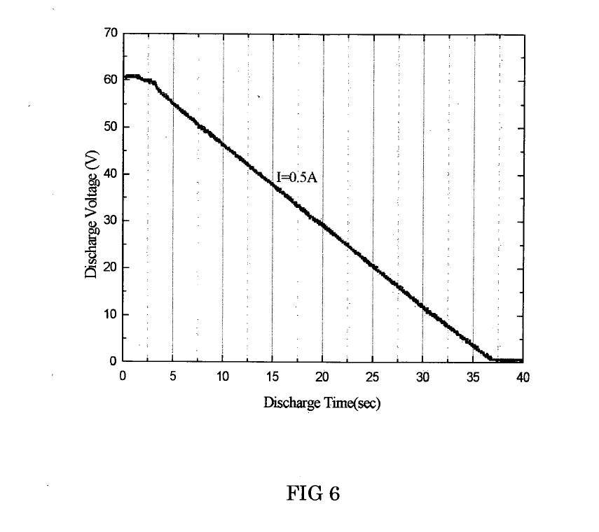

As seen in Table 3, the supercapacitors may have a working voltage of 65.0 V or 67.5 V, their leakage currents are much lower when the supercapacitors are operated at lower voltages. Just like other electronic components, utilization of supercapacitors at lower voltages, that is, less stress, the lifetime of the devices will be greatly prolonged. Since the “intra-element series connection” of the invention can conveniently produce the bipolar supercapacitors, particularly, the stacked type, in extremely high working voltages, thus, even at 2.0 V per cell, the devices will still have sufficient room of voltage to revolutionize many high power applications. FIG. 6 is a typical discharge curve of the supercapacitors of Table 2, and it shows an excellent behavior for a 60-V supercapacitor in a single package that has not been made before.

### CONCLUSION

The above examples validate the feasibility of the “intra-element series connection” of the invention on fabricating the bipolar supercapacitor devices in high working-voltages, but in small volumes. Using the “intra-housing series, parallel, or combinatory connections”, the present invention further enhances the energy density of bipolar supercapacitors by integrating multiple elements into compact modules. Therefore, using high working-voltage elements as the building blocks, various concise and self-sustained energy-storage devices or modules can be custom made for electronic products, electric vehicles, automatic machineries and public utilities.

Through a series connection of multiple electrodes within a single element, a single unit of supercapacitor with high working-voltage can be fabricated. Similarly, an intra-housing series connection of multiple elements within a single case can produce a compact supercapacitor module with very high working-voltage. The said assemblies of making high-voltage supercapacitors in single units or modules can facilitate the usage of the devices as power managers in high power applications for automobiles, power tools, machineries and automatic systems.

### INDUSTRIAL APPLICABILITY

The bipolar element and the bipolar supercapacitor according to the present invention can be used in high power applications for automobiles, power tools, machineries and automatic system.

1. A bipolar element for energy storage comprising:
two end electrodes with a dedicated means for connecting to a potential source;
at least one intervening electrode disposed between the end electrodes or after each of the end electrodes, wherein the intervening electrode has no connection to a potential source;
a separator disposed after each of the electrodes for concentrically winding the electrodes and the separators into a round element;
one end of the round element being sealed with the adhesive;
the other end of the round element being injected with an electrolyte to saturate the electrodes and the separators; and
a housing for containing the sealed and soaked round element to form an energy-storage device that contains two identical bipolar groups wherein all electrodes are connected in series, and the two bipolar groups are connected in parallel by sharing the two end electrodes.

2. The bipolar element as claimed in claim 1, wherein the end of the round element chosen for electrolyte injection has no connection means to a potential source.

3. The bipolar element as claimed in claim 1, wherein the round element is sealed by means of dip coating, spin coating, or injection molding.

4. The bipolar element as claimed in claim 1, wherein the adhesive is selected from the group consisting of epoxy, silicone, rubber, urethane, and a combination of the above.

5. The bipolar element as claimed in claim 1, wherein the electrolyte is an organic solution containing a solute selected from the group consisting of tetraethyl ammonium tetrafluoroborate, tetramethyl ammonium tetrafluoroborate, and methyl triethyl ammonium tetrafluoroborate.

6. The bipolar element as claimed in claim 1, wherein the electrolyte is an organic solution containing a solvent selected from the group consisting of acetonitrile, dimethyl carbonate, diethyl carbonate, ethylene carbonate, methyl ethyl carbonate, methyl propyl carbonate, propylene carbonate, γ-butyrolactone, and a combination of the above.

7. The bipolar element as claimed in claim 1, wherein each of the bipolar groups has a working voltage determined by the product of 2.5 V and the number of intervening electrodes.

8. The bipolar element as claimed in claim 1, wherein each of the bipolar groups has a capacitance determined by the surface area of the electrodes constituting the bipolar groups.

9. The bipolar element as claimed in claim 1, wherein the bipolar element has an overall capacitance equals to the sum of the capacitances of the bipolar groups.

10. A bipolar supercapacitor for energy storage comprising:
two end electrodes with a dedicated means for connecting to a potential source;
at least one intervening electrode juxtaposed between the end electrodes wherein the intervening electrode has no connection to a potential source;
a separator inserted between the electrodes located adjacent to each other to form a prismatic element;
the prismatic element has two ends for attaching physical means for connecting to a potential source, as well as four sides with no connection to a potential source;
three sides of the prismatic element being sealed with an adhesive;
the remaining one side of the prismatic element being injected with an organic electrolyte to saturate the electrodes and the separators; and
a housing with a cap for hermetically containing the sealed and soaked prismatic element to form a bipolar supercapacitor that contains at least three of the electrodes connected in series.

11. The bipolar supercapacitor as claimed in claim 10, wherein the supercapacitor has a working voltage determined by the product of 2.5 V and the number of intervening electrodes.

12. The bipolar supercapacitor as claimed in claim 10, wherein the housing has no separate compartments.

13. The bipolar supercapacitor as claimed in claim 10, wherein the sealing of the sides of the prismatic element can confine the organic electrolyte within each space defined by two of the electrodes facing each other.

14. (canceled)
